(19) United States
(12) Patent Application Publication
(10) Pub. No.: US 2013/0311153 A1
(43) Pub. Date: Nov. 21, 2013

(54) VIRTUAL ENVIRONMENT AND METHOD FOR SORTING AMONG POTENTIAL ROUTE PLANS FOR OPERATING AUTONOMOUS MACHINE AT WORK SITE

(71) Applicants: Eric Alan Moughler, Germantown Hills, IL (US); Craig Lawrence Koehrsen, East Peoria, IL (US); Douglas William Horton, Mapleton, IL (US)

(72) Inventors: Eric Alan Moughler, Germantown Hills, IL (US); Craig Lawrence Koehrsen, East Peoria, IL (US); Douglas William Horton, Mapleton, IL (US)

(73) Assignee: CATERPILLAR INC., Peoria, IL (US)

(21) Appl. No.: 13/471,834

(22) Filed: May 15, 2012

(51) Int. Cl. G06G 7/70

(52) U.S. Cl. 703/6

(57) ABSTRACT

A method for sorting among a plurality of potential route plans for operating an autonomous ground based machine includes a step of creating a virtual model of a terrain of a work site. A first virtual lane having at least one measurable lane constraint is created within the virtual model. A first virtual machine footprint is created and has a first virtual movement profile corresponding to an actual autonomous movement profile of the autonomous machine. The first virtual machine footprint is moved from a starting position along the first virtual lane to an ending position according to the first virtual movement profile. During the moving step, the first virtual machine footprint is compared to the at least one measurable lane constraint. The first proposed route plan is then designated as either viable or unacceptable based on the comparison.

### TECHNICAL FIELD

The present disclosure relates generally to a virtual environment, and more particularly to a virtual environment and method for evaluating a proposed route plan for operating an autonomous machine at a work site.

### BACKGROUND

Utilization of autonomous machines is becoming more prevalent and offers particular advantages in the mining industry. Specifically, autonomous machines may be operated in environments unsuitable for human operators, such as, for example, at high altitudes or in sparsely populated desert regions. In addition, autonomous machines may be operated for longer periods of time than manned machines, thus providing increased productivity, and may be operated according to strict control strategies aimed at optimizing efficiency and reducing emissions. Further, by optimizing operation, maintenance costs for the autonomous machine may potentially be reduced.

Autonomous control is accomplished by providing the autonomous machine with a machine control system that includes a positioning unit and a navigation unit. The navigation unit uses machine position and orientation information generated by the positioning unit to maneuver the autonomous machine according to a route plan, which includes, for example, designated lanes, travel paths, routes, hazards, and the like. The route plan may be generated and updated at a central control system and transmitted to the autonomous machine, as needed. Typically, the route plan will be validated to ensure the autonomous machine may successfully navigate the designated lanes. In particular, a manned, autonomous, or semi-autonomous machine may be operated along a constructed lane at the mine site to verify the suitability of the lane for autonomous operation prior to the incorporation of the constructed lane into the route plan. This real world validation may be both time consuming and costly, particularly if the constructed lane is found to be unsuitable and must be modified or moved.

U.S. Pat. No. 6,393,362 to Burns teaches an onboard strategy for autonomous vehicle collision avoidance. In particular, the strategy of Burns teaches the creation of a safety envelope corresponding to each of the autonomous vehicles that is based on the vehicle's geometry, speed, and guidance control errors and/or tolerances. Positions of the safety envelopes are predicted as each of the autonomous vehicles travel along a trajectory. If a potential overlap of safety envelopes of two or more vehicles is identified, a control strategy for one of the autonomous vehicles is modified to avoid the potential collision. This onboard control strategy may prove useful in real-time vehicle avoidance, but does not teach or suggest autonomous vehicle simulation for route planning purposes.

The present disclosure is directed to one or more of the problems or issues set forth above.

### SUMMARY OF THE DISCLOSURE

In one aspect, a method for sorting among a plurality of potential route plans for operating an autonomous ground based machine at a work site includes a step of creating a virtual model of a terrain of the work site. A first virtual lane, which corresponds to a first proposed route plan of the plurality of potential route plans and has at least one measurable lane constraint, is created within the virtual model. A first virtual machine footprint, corresponding to an actual footprint of the autonomous ground based machine, is created and has a first virtual movement profile. The first virtual movement profile corresponds to an actual autonomous movement profile of the autonomous ground based machine. The first virtual machine footprint is moved from a starting position along the first virtual lane to an ending position along the first virtual lane according to the first virtual movement profile. During the moving step, the first virtual machine footprint is compared to the at least one measurable lane constraint. The first proposed route plan is then designated as either viable or unacceptable based on the comparison of the first virtual machine footprint to the at least one measurable lane constraint.

In another aspect, a virtual environment for sorting among a plurality of potential route plans for operating an autonomous ground based machine at a work site includes a virtual model of a terrain of the work site. The virtual model also includes a first virtual lane corresponding to a first proposed route plan of the plurality of potential route plans and having at least one measurable lane constraint. A first virtual machine footprint corresponding to an actual footprint of the autonomous ground based machine has a first virtual movement profile corresponding to an actual autonomous movement profile of the autonomous ground based machine. An electronic processor is configured to move the first virtual machine footprint from a starting position along the first virtual lane to an ending position along the first virtual lane according to the first virtual movement profile. The electronic processor compares the first virtual machine footprint to the at least one measurable lane constraint while the first virtual machine footprint is moving, and designates the first proposed route plan as either viable or unacceptable based on the comparison of the first virtual machine footprint to the at least one measurable lane constraint.

### BRIEF DESCRIPTION OF THE DRAWINGS

FIG. 1 is a schematic diagram of an exemplary system for operating an autonomous machine at a work site, according to the present disclosure;

FIG. 2 is a graphical representation of a virtual environment, depicting a simulation of a first virtual machine footprint along a first virtual lane corresponding to a first proposed route plan, according to one aspect of the present disclosure;

FIG. 3 is another graphical representation of the virtual environment, depicting a simulation of a second virtual machine footprint along the first virtual lane, according to another aspect of the present disclosure;

FIG. 4 is another graphical representation of the virtual environment, depicting a simulation of the second virtual machine footprint along a second virtual lane corresponding to a second proposed route plan, according to another aspect of the present disclosure;

FIG. 5 is another graphical representation of the virtual environment, depicting a simulation of a plurality of virtual machine footprints along a first virtual lane of a third proposed route plan according to an exemplary work cycle, with respect to another aspect of the present disclosure;

FIG. 6 is another graphical representation of the virtual environment, depicting a simulation of a plurality of virtual machine footprints along first and second intersecting virtual lanes of a fourth proposed route plan according to another exemplary work cycle, according to another aspect of the present disclosure;

FIG. 7 is another graphical representation of the virtual environment, depicting a simulation of a plurality of virtual machine footprints along first and second intersecting virtual lanes of a fifth proposed route plan, according to another exemplary work cycle, according to another aspect of the present disclosure; and

FIG. 8 is an exemplary chart depicting evaluation designations assigned to each of the plurality of potential route plans based on the previously depicted simulations, according to another aspect of the present disclosure.

### DETAILED DESCRIPTION

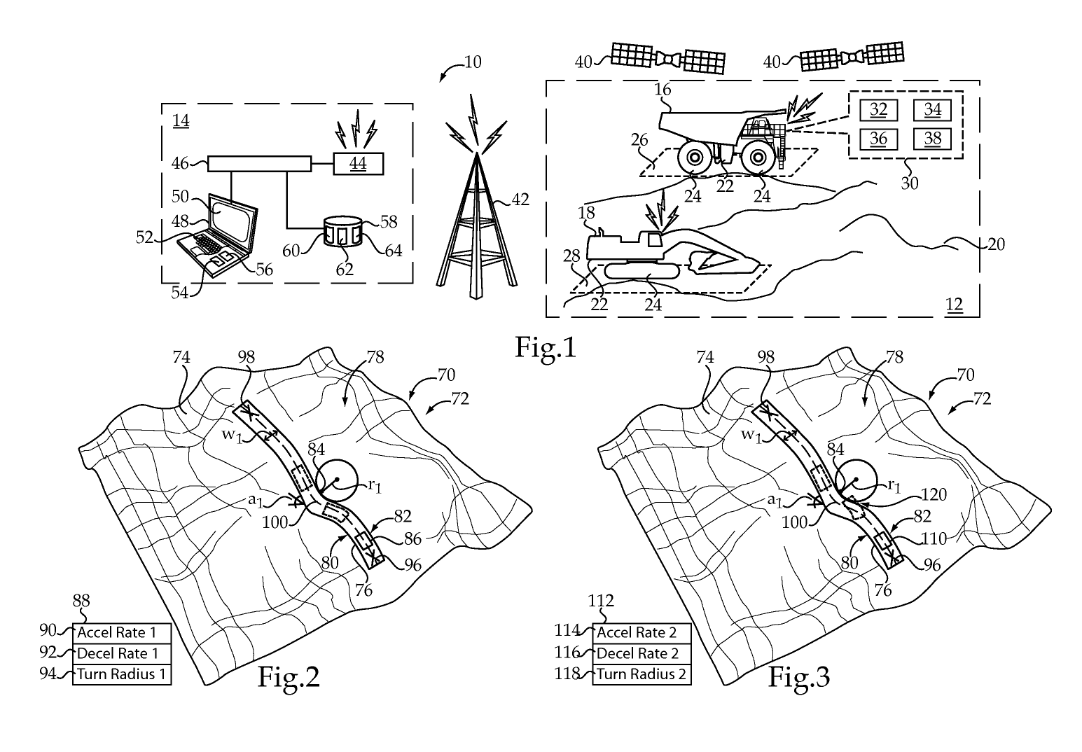

Referring to FIG. 1, a control system 10 for a work site 12 includes a central control system 14 communicatively coupled with a first autonomous machine 16 and a second autonomous machine 18 at the work site 12. According to a specific example, the work site 12 may be a mine environment utilizing heavy equipment, such as excavators, backhoes, front-end loaders, mining shovels, etc., to excavate and transport materials across a terrain 20 from a mine site to a production facility. Each of the autonomous machines 16 and 18 are equipped for land, or ground, based travel and include a chassis 22 supporting a plurality of ground engaging elements 24. As should be appreciated, the autonomous machines 16 and 18 occupy actual footprints 26 and 28, respectively, relative to the terrain 20. Although specific work site and machine embodiments are described, it should be appreciated that the virtual environment and method described herein are broadly applicable to a variety of work sites including any combination of autonomous, semi-autonomous, and manned machines.

Each of the autonomous machines 16 and 18 may include a machine control system 30 supported on the chassis 22. For example, the machine control system 30 of autonomous machine 16 may include an electronic controller 32, a positioning unit 34, and a navigation unit 36. The electronic controller 32 may be configured for drive-by-wire operation of the autonomous machine 16 and, thus, may be in control communication with various components of the machine 16 to control at least the speed and direction of travel of the machine 16 according to an autonomous machine movement profile 38. The autonomous machine movement profile 38, as will be described below, may include at least a predetermined acceleration rate, a predetermined deceleration rate, and a predetermined turning radius for the machine 16. As should be appreciated, the electronic controller 32 may also be in communication with various sensors and devices in order to monitor and, thus, effectively control the operation of the autonomous machine 16. Although a control strategy is described with specific reference to machine 16, it should be appreciated that autonomous machine 18 may be controlled in a similar manner.

The navigation unit 36 may receive, access, and/or store a route plan that may be used to control operation of the autonomous machine 16. For example, the route plan may include a map of the work site 12 that includes positions of the equipment, materials, hazards, etc. located at the work site. The route plan may also include an intended travel path along a lane associated with a task for the machine 16. The navigation unit 36 may be in communication with the positioning unit 34, which may include one or more Global Positioning System (GPS) units receiving information from satellites 40 to calculate machine position information. The navigation unit 36 may use the machine position information to ascertain where the autonomous machine 16 is currently located and where, according to the route plan, the machine 16 must go. In particular, the navigation unit 36 may receive an intended travel path for the machine 16 from the route plan and may communicate with the electronic controller 32 to maneuver the machine 16, such as by controlling propulsion, steering, braking, and the like, according to the instructions set out for the machine 16.

The electronic controller 32, the navigation unit 36, and the positioning unit 34 may each be of standard design and may include a processor, such as, for example, a central processing unit, a memory, and an input/output circuit that facilitates communication internal and external to the respective electronic device 32, 34, or 36. The processor may control operation of the respective electronic controller 32, navigation unit 36, or positioning unit 34 by executing operating instructions, such as, for example, computer readable program code stored in memory, wherein operations may be initiated internally or externally to the respective electronic device 32, 34, or 36. A control scheme may be utilized that monitors outputs of systems or devices, such as, for example, sensors, actuators, or control units, via the input/output circuit to control inputs to various other systems or devices.

The memory may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. Such devices may be located internally or externally to the respective electronic controller 32, navigation unit 36, or positioning unit 34. One skilled in the art will appreciate that any computer based system or device utilizing similar components for controlling the components of the autonomous machine 16 or 18 is suitable for use with the present disclosure.

As should be appreciated, each of the autonomous machines 16 and 18 may include other systems and/or components to effect autonomous control. For example, the autonomous machines 16 and 18 may also be equipped with inertial measurement devices, which tell the machine control systems 30 how the respective machine 16, 18 is moving. The machine control system 30 may also include additional obstacle detection and avoidance features, including laser, vision, and radar sensors. All of these devices may be used in known ways to maneuver the autonomous machines 16 and 18 according to instructions provided in the route plan.

The machine position information from each of the autonomous machines 16 and 18 may be transmitted from the machines 16 and 18 to the central control system 14. In particular, each machine 16, 18 may include a wireless transceiver for communicating with the central control system 14 over a wireless network, such as via a wireless communication tower 42. A wireless transceiver 44 of the central control system 14 may communicatively couple the wireless communication tower 42 with a network 46. As should be appreciated, the network 46 may include information devices adapted to communicate over various wired or wireless media, such as, for example, cables, phone lines, fiber optic lines, radio waves, power lines, or the like. In addition, the network 46 may be private, public, packet-switched, circuit-switched, local area, wide area, Internet, intranet, IP, wireless, and/or any equivalents thereof.

The central control system 14 may also include a computing device, such as a computer 48, having a display or graphical interface 50 and an input device 52. The computer 48 may also include an electronic processor 54, such as a central processing unit, and a memory 56, and may be in communication with a database 58 via the network 46. The components of the computer 48 may be similar to the electronic controller 32, the navigation unit 36, and the positioning unit 34 and, thus, will not be described in further detail. The memory 56 and/or database 58 may include a software program or algorithm 60, which may include computer readable program code executable by the processor 54, to perform the functionality described herein. The memory 56 and/or database 58 may also store one or more route plans 62 for controlling the operation of autonomous machines 16 and 18 at the mine site 12. Further, the memory 56 and/or database 58 may store virtual movement profiles 64, which will be accessed and utilized as described below.

Turning now to FIG. 2, a virtual environment 70 for sorting among a plurality of potential route plans for operating the autonomous machine 16, 18 at the work site 12 will be described. The virtual environment 70 may be created at the central control system 14 or, more particularly, at the computer 48, and may include a graphical depiction 72, which may be displayed on display 50. The virtual environment 70 may be electronically constructed by first creating a virtual model 74 of the actual terrain 20 of the work site 12. The virtual terrain model 74 may be created by use of a computer aided design (CAD) program, such as AutoCAD, which is provided by Autodesk, Inc. of San Rafael, Calif. The virtual terrain model 74 may depict the topography and contours of the mine site 12 and may be constructed using aerial maps, previous topographic maps, survey reports, and the like.

Next, a first virtual lane 76 corresponding to a first proposed route plan 78 may be created within the virtual environment 70. In particular, the first virtual lane 76 may represent a potential or proposed lane or road through the mine site 12 that may be incorporated into a route plan. To evaluate lane suitability, the potential lane may be modeled along the virtual terrain 74 as first virtual lane 76. The first virtual lane 76 has a plurality of measurable lane constraints, which are based on proposed lane constraints, including a width w₁ defined by a left-hand boundary 80 and a right-hand boundary 82. The first virtual lane 76 also has a plurality of curves, which may be evaluated, for example, by measuring a radius of the curvature r₁ at point 84. The radius of curvature may be calculated using the equation: {[1+(dy/dx)̂2]̂3/2}/|d̂2y/dx̂2|, where x and y are Cartesian coordinates at the point 84. Although a specific example is provided, it should be appreciated that the curvature of first virtual lane 76 may be calculated using any known equation.

The first virtual lane 76 may also have an angle of inclination a₁ relative to the horizontal at any given point along the lane 76. Although inclination angle is described, it should be appreciated that the grade or slope of the first virtual lane 76 may be measured or calculated in any number of ways to arrive at a representative value. The measurable lane constraints may be stored in the memory 56 and/or database 58 and may be provided for any or all points along a length of the first virtual lane 76. Although specific examples are provided, it should be appreciated that the first virtual lane 76 may have additional and/or alternative measurable lane constraints that may be modeled in the virtual environment 70.

A first virtual machine footprint 86, which may correspond to the actual footprint 26 of autonomous machine 16, may also be created in the virtual environment 70. In particular, the first virtual machine footprint 86 may represent the two-dimensional, or three-dimensional, space occupied by the autonomous machine 16 in the virtual environment 70, and may correspond to a coordinate system, in relation to the first virtual lane 76. Further, the orientation, or angular shifting, of the first virtual machine footprint 86 may also be represented in the virtual environment 70. The first virtual machine footprint 86 may be initialized at a desired position and orientation within the virtual environment 70, which may correspond to a desired starting position for the machine 16 at the mine site 12.

The first virtual machine footprint 86 has a first virtual movement profile 88, which may correspond to the actual autonomous movement profile 38 of the autonomous machine 16. In particular, the same logic from the machine control system 30 described above may be used to control movement of the first virtual machine footprint 86 in the virtual environment 70. In particular, the first virtual movement profile 88 may include at least a predetermined acceleration rate 90, a predetermined deceleration rate 92, and a predetermined turning radius 94, which each correspond to the respective value provided in the actual autonomous movement profile 38 for the machine 16.

After the proposed lane or road has been modeled in the virtual environment 70 as first virtual lane 76, and the first virtual machine footprint 86 has been created and initialized relative to the first virtual lane 76, the processor 54 moves the first virtual machine footprint 86 from a starting position 96 along the first virtual lane 76 to an ending position 98 along the first virtual lane 76. In particular, the processor 54 moves the first virtual machine footprint 86 along an intended travel path 100, which may represent a centerline of the first virtual lane 76, according to the first virtual movement profile 88. In particular, the processor 54 is provided with a map (i.e., the virtual terrain 74 and first virtual lane 76) and is instructed to move the first virtual machine footprint 86 from the starting position 96 to the ending position 98 along the lane 76 according to the first virtual movement profile 88. As should be appreciated, by moving the first virtual machine footprint 86 along the intended travel path 100 according to the first virtual movement profile 88, movement of the autonomous machine 16 along a proposed lane or road represented by the first virtual lane 76 may be simulated.

While the first virtual machine footprint 86 is moved along the first virtual lane 76, the first virtual machine footprint 86, along with aspects of the first virtual movement profile 88, are compared to one or more of the measurable lane constraints. For example, dimensions of the first virtual machine footprint 86 may be compared to the width w₁ of the first virtual lane 76 as the virtual machine footprint 86 is moved along the intended travel path 100 according to the movement profile 90. In particular, the first virtual machine footprint 86 may be compared to the boundaries 80 and 82 to identify a breach of the boundaries 80 and 82 during the simulated movement. Such a simulation may predict whether the autonomous machine 16 would breach real life boundaries of the proposed lane, if the proposed lane were constructed at the mine site 12.

In addition, the turning radius 94 of the first virtual machine footprint 86 may be compared to the curvature of the first virtual lane 76, as indicated by the radius of curvature r₁, while the first virtual machine footprint 86 is moved along the first virtual lane 76. The movement capabilities of the first virtual machine footprint 86, as defined by the first virtual movement profile 88, may also be compared to the dynamic angles of inclination a₁ of the first virtual lane 76 as the first virtual machine footprint 86 is moved along the intended travel path 100. As such, the simulation may predict whether the autonomous machine 16 would be capable of navigating the curves and grades of the proposed road while the machine 16 is operated autonomously.

These comparisons, along with comparisons of other measurable lane constraints, may be used by the processor 54 to designate the first proposed route plan 78 or, more specifically, the first virtual lane 76 as either viable or unacceptable. Although additional criteria may be used, an “unacceptable” route plan or lane may be one that cannot be successfully traversed by the autonomous machines 16, 18 given the predetermined constraints, while a “viable” route plan or lane may be one that is successfully traversed in the virtual environment 70. For example, if the first virtual machine footprint 86 crosses one of the boundaries 80 and 82 during the simulated movement, the first virtual lane 76 may be deemed unacceptable. If, however, the first virtual machine footprint 86 does not cross the boundaries 80 and 82, the first virtual lane 76 may be deemed viable. Of course, it may be desirable to determine whether or not a route plan is viable based on an evaluation of any or all of the measurable lane constraints.

For exemplary purposes, the processor 54 may determine that the first virtual machine footprint 86 successfully traverses the first virtual lane 76, when moved according to the first virtual movement profile 88 and compared to the provided constraints. However, if different types of machines are to be operated along the proposed road, it may be desirable to simulate movement of different machines (i.e., machines having different footprints and different machine movement profiles) along the first virtual lane 76. For example, as shown in FIG. 3, a second virtual machine footprint 110 may be created which corresponds to the actual footprint 28 of the autonomous machine 18 and has a second virtual movement profile 112 that is different than the first virtual movement profile 88. Specifically, the second virtual movement profile 112 may correspond to an actual movement profile of the autonomous machine 18 and may include at least a predetermined acceleration rate 114, a predetermined deceleration rate 116, and a predetermined turning radius 118.

After the second virtual machine footprint 110 is created and initialized, the processor 54 may also be configured to move the second virtual machine footprint 110 from the starting position 96 along the first virtual lane 76 to the ending position 98 along the first virtual lane 76. While the second virtual machine footprint 110 is moved along the first virtual lane 76, the second virtual machine footprint 110, along with aspects of the second virtual movement profile 112, are compared to one or more of the measurable lane constraints of the first virtual lane 76. For example, dimensions of the second virtual machine footprint 110, which may be different than those of the first virtual machine footprint 86, may be compared to the width w₁ of the first virtual lane 76 during the simulated movement. In addition, the turning radius 118 of the second virtual machine footprint 110 may be compared to the curvature of the first virtual lane 76, as indicated by the radius of curvature r₁. Further, the movement capabilities of the second virtual machine footprint 110, as defined by the second virtual movement profile 112, may also be compared to the dynamic angles of inclination a₁ of the first virtual lane 76 as the second virtual machine footprint 110 is moved along the intended travel path 100.

These comparisons, along with the comparisons of the first virtual machine footprint 86 relative to the measurable lane constraints, may be used by the processor 54 to designate the first proposed route plan 78 or, more specifically, the first virtual lane 76 as either viable or unacceptable. For exemplary purposes, the processor 54 may identify a breach of the boundaries 80 and 82 during movement of the second virtual machine footprint 110 along the first virtual lane 76, as shown at a simulated position 120 of the second virtual machine footprint 110. As such, although the first virtual machine footprint 86 successfully traversed the first virtual lane 76, the first virtual lane 76 may be deemed unacceptable because of the identified boundary breach with respect to the second virtual machine footprint 110.

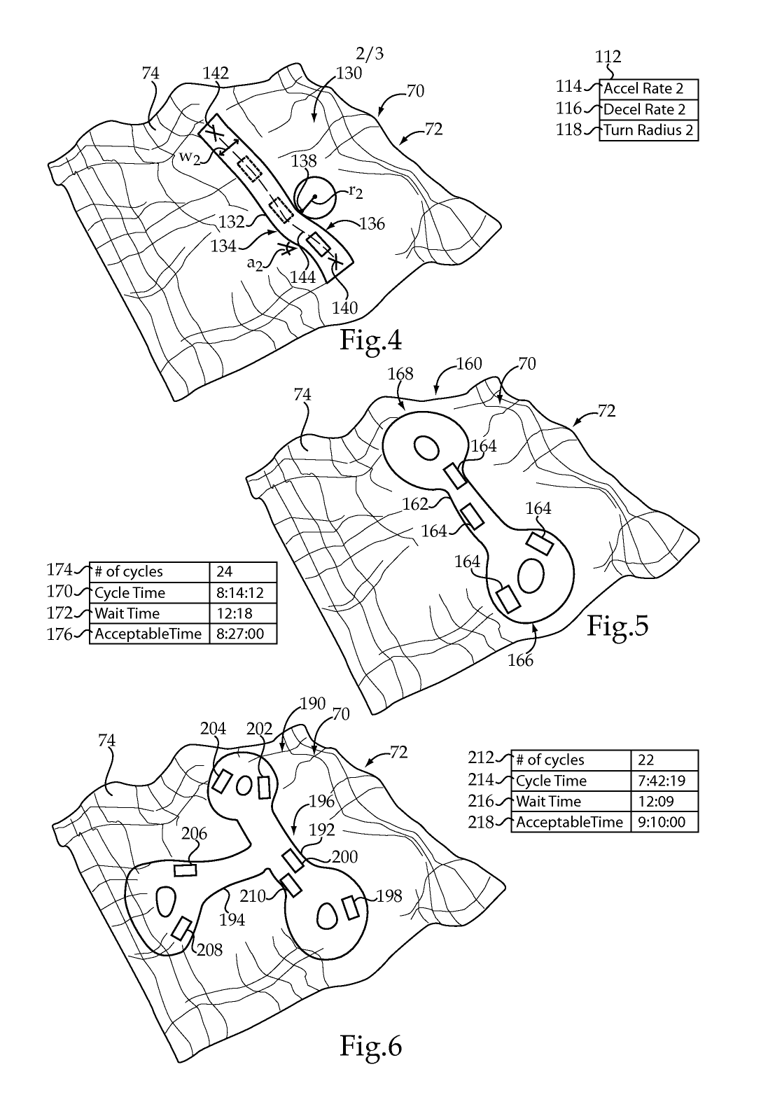

If the first proposed route plan 78 or first virtual land 76 is deemed unacceptable, it may be desirable to evaluate an alternative route plan or road in the virtual environment 70. Turning now to FIG. 4, the virtual environment 70 may be used to evaluate a second proposed route plan 130 having a virtual lane 132 that is different than the first virtual lane 76. In particular, the virtual lane 132 may have different measurable lane constraint values than those of the first virtual lane 76. For example, if it was determined that the autonomous machine 18 is unable to navigate the curves of the first virtual lane 76 based on the simulation, it may be desirable to propose or model a lane having smaller curvature radii than the first virtual lane 76. As shown, the alternative virtual lane 132 has a width w₂ defined by a left-hand boundary 134 and a right-hand boundary 136. The virtual lane 132 also has a plurality of curves, which may be evaluated, for example, by measuring a radius of the curvature r₂ at a point 138, and an angle of inclination a₂ relative to the horizontal at any given point along the lane 132.

The processor 54 may move the second virtual machine footprint 110 from a starting position 140 along the virtual lane 132 to an ending position 142 along the virtual lane 132. In particular, the processor 54 may be configured to move the second virtual machine footprint 110 along an intended travel path 144, which may represent a centerline of the virtual lane 132, according to the second virtual movement profile 112. During the simulated movement, dimensions of the second virtual machine footprint 110 may be compared to the width w₂ of the virtual lane 132. In addition, the turning radius 118 of the second virtual machine footprint 110 may be compared to the curvature of the virtual lane 132, as indicated by the radius of curvature r₂, and the movement capabilities of the second virtual machine footprint 110 may be compared to the dynamic angles of inclination a₂ of the virtual lane 132. As such, the simulation may predict whether the autonomous machine 18 would be capable of navigating the proposed road while the machine 18 is operated autonomously. If it is determined that the second virtual machine footprint 110 successfully traverses the virtual lane 132, it may be desirable to evaluate movement of different machines along the virtual lane 132. If all of the machines that might operate along the proposed route can successfully traverse the virtual lane 132, the second proposed route plan 130 may be deemed viable.

The processor 54 may also be configured to measure and evaluate additional parameters during the simulation. For example, turning now to FIG. 5, a third proposed route plan 160 may be evaluated in the virtual environment 70. In particular, the third proposed route plan 160 may include a virtual lane 162 having a plurality of measurable lane constraints that is modeled along the virtual terrain 74. The third proposed route plan 160 may also include instructions for moving a plurality of virtual machine footprints 164, which may correspond to a fleet of autonomous vehicles, according to a predetermined work cycle. For example, the work cycle may include the movement of material from one location 166 to another location 168. It should be appreciated that the precise locations 166 and 168 within the virtual environment 70 may correspond to actual locations at the mine site 12.

The processor 54 may move the fleet of virtual machine footprints 164 along the virtual lane 162, which may be a two-lane road, according to the respective virtual machine movement profile of each of the machine footprints 164. In addition to comparing the fleet of machine footprints 164 and the respective virtual machine movement profiles to the measurable lane constraints of the virtual lane 162, as described above, the processor 54 may evaluate additional parameters, including a cycle time 170 and a wait time 172.

For example, an exemplary work cycle for a fleet of autonomous machines may include loading material at the first location 166, hauling the material from the first location 166 to the second location 168, unloading the material at the second location 168, and returning to the first location 166. The processor 54 may be configured to simulate movement of the virtual machine footprints 164 according to this work cycle for a predetermined number of cycle times 174 or until another measurable criteria are met. The cycle time 170 and wait time 172 may both be initialized to zero and, when the simulation begins, may be incremented as desired.

The cycle time 170 may be configured to measure elapsed time and, thus, may provide a total time required for executing the defined work cycle a predetermined number of times or until the task is completed. The wait time 172 may keep track of the time that one or more of the virtual autonomous machine footprints 164 is required to wait, or maintain a stationary position, during the simulation. For example, a machine may be required to wait if an upcoming destination is occupied or if there is a delay during loading and/or unloading. High wait times 172 may indicate decreased efficiency and/or productivity and may prompt reevaluation of the proposed route plan 160. To aid in the evaluation, the wait time 172 and/or cycle time 170 may be compared to one or more acceptable time values 176. Based on the comparison, the proposed route plan 160 may be designated as either viable or unacceptable.

A fourth proposed route plan 190 may be evaluated in the virtual environment 70, as described with reference to FIG. 6. In particular, the fourth proposed route plan 190 may include a first virtual lane 192 and a second virtual lane 194, both of which have a plurality of measurable lane constraints. The first and second virtual lanes 192 and 194 may be two-lane roads and may have at least one intersection 196, as shown. The fourth proposed route plan 190 may also include instructions for moving a plurality of virtual machine footprints 198-210 according to respective virtual movement profiles and according to a predetermined work cycle. For example, the work cycle may be similar to the work cycle described above with reference to FIG. 5 and may include the movement of materials at the mine site 12.

The processor 54 may be configured to simulate movement of the virtual machine footprints 198-210 according to the work cycle for a predetermined number of cycle times 212 or until other measurable criteria are met. A cycle time 214 and a wait time 216 may both be initialized to zero and, when the simulation begins, may be incremented as described above, and either or both of the times 214 and 216 may be compared to one or more acceptable time values 218. As with autonomous control in the real environment, the virtual machine footprints 198-210 in the virtual environment 70 should be aware of the current positions of other of the machine footprints 198-210 to avoid collision. As such, the processor 54 may also be configured to modify movement of one of the virtual machine footprints 198-210 based on a current virtual position of another of the virtual machine footprints 198-210. Thus, as should be appreciated, the wait time 216 and/or cycle time 214 may be affected by traffic flow.

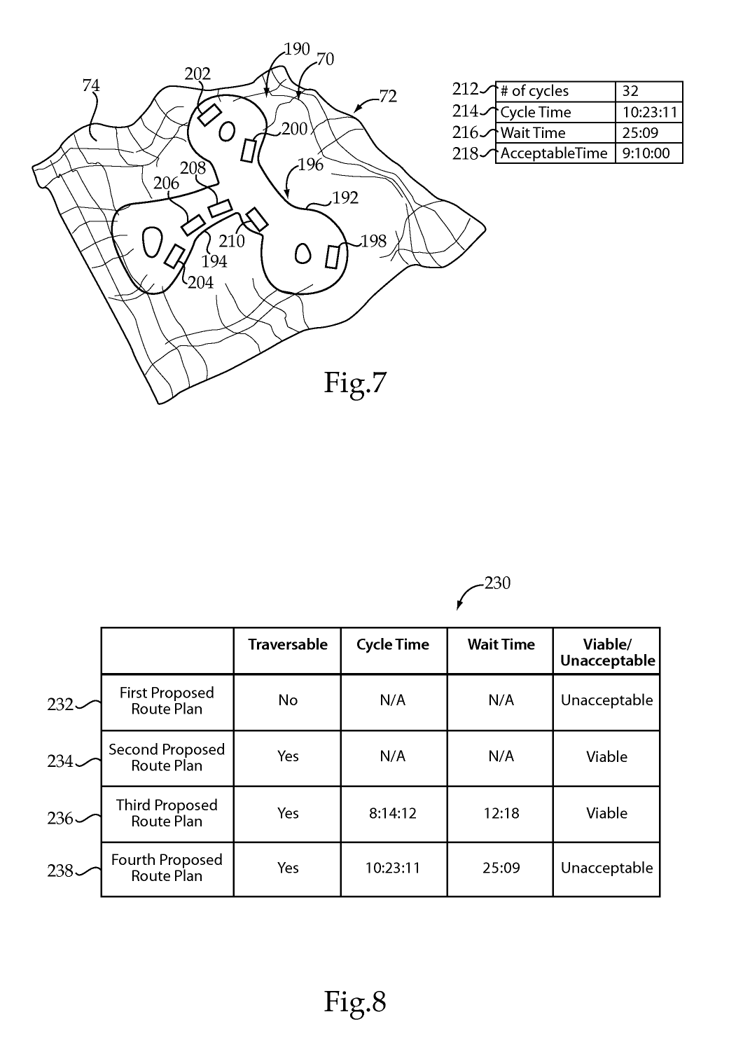

After a predetermined period of time, such as after the simulation has run a predetermined number of cycle times 212, the cycle time 214 and/or the wait time 216 may increase, such as above the acceptable time value 218, as shown in FIG. 7. In particular, the proposed route plan 190 may be evaluated based on operation for 32 cycles. As shown in FIG. 7, the elapsed time for completing the 32 cycles was 10:23:11, which is greater than the acceptable cycle time of 9:10:00. As such, the fourth proposed route plan 190 may be deemed unacceptable and aspects of the route plan 190 may be re-evaluated and revised. It should be appreciated that an undesirable wait time 216 may also render the proposed route plan 190 unacceptable. Although determinations regarding the suitability of a route plan may be made based on comparisons to measurable constraints, it should be appreciated that some determinations may be made based on visual inspection of the simulation. For example, as reflected in FIG. 7, it may be apparent from visual observation that bunching is occurring near the intersection 196.

As shown in FIG. 8, a chart 230 depicting evaluation designations assigned to each of the plurality of potential route plans 78, 130, 160, and 190 may be created and stored at the central control system 14. Row 232 reflects the determination that the proposed route plan 78 is unacceptable at least because the second virtual machine footprint 110 was unable to successfully navigate the first virtual path 76 within the given constraints. The second proposed route plan 130, however, was deemed viable, as shown in row 234 of the chart 230. The third proposed route plan 160 was deemed viable after evaluating measurable lane constraints and additional criteria related to proposed work cycles, as reflected in row 236. Finally, the fourth proposed route plan 190, as shown in row 238, was determined to be unacceptable due to traffic flow issues, as indicated by cycle and/or wait time evaluations and visual observation.

When a plurality of proposed route plans, lanes, or roads are evaluated using the virtual environment 70, it may be desirable to sort or rank the modeled plans or lanes based on measurable results. Thus, additional simulation data may be collected, stored, and used to facilitate such evaluations. Regardless of the number of route plans or roads that are evaluated using the virtual environment 70, it should be appreciated that the modeling and simulation in the virtual world 70 may save considerable time and money during the route planning process. As should be appreciated, an actual lane or road may only be constructed at the actual mine site 12 after it has been evaluated in the virtual world 70 and deemed suitable for autonomous machine traversal.

### INDUSTRIAL APPLICABILITY

The present disclosure finds potential application in route planning for a work site. Further, the present disclosure may be specifically applicable to a virtual environment and method for evaluating a proposed route plan for operating an autonomous machine at the work site. Yet further, the disclosure may be applicable to sorting a plurality of potential lanes for a route plan for an autonomous machine. Such work sites may include mining environments utilizing autonomous and manned heavy equipment, such as excavators, backhoes, front-end loaders, mining shovels, etc., to excavate and transport materials from a mine site to a production facility.

Referring generally to FIGS. 1-8, an exemplary control system 10 for an autonomous work site 12 includes a central control system 14 communicatively coupled with autonomous machines 16 and 18 at the work site 12. The autonomous machines 16 and 18 may each include a control system 30 supported on a chassis 22 and including an electronic controller 32, a positioning unit 34, and a navigation unit 36. The electronic controller 32 is configured for drive-by-wire operation of the autonomous machine 16, 18 and, thus, is in control communication with various components of the machine 16, 18, including the positioning unit 34 and the navigation unit 36, to control at least the speed and direction of travel of the machine 16, 18. Generally, the navigation unit 36 may receive route plan information, such as from stored route plans 62, from the central control system 14 that is used to control operation of the autonomous machine 16, 18.

Typically, the route plan information 62 will be validated to ensure the autonomous machines 16 and 18 may successfully navigate the designated lanes. In particular, a manned, autonomous, or semi-autonomous machine may be operated along a constructed lane at the mine site 12 to verify the suitability of the lane for autonomous operation prior to the incorporation of the constructed lane into the route plan 62. Although this real world validation is beneficial, actual machine operation at the mine site 12 for testing or validation purposes is both time consuming and costly, particularly if the constructed lane is found to be unsuitable and must be modified or moved. The virtual environment 70 and methods described herein provide an efficient and less costly alternative to real world route plan validation.

In particular, and as described above, one or more proposed roads may be modeled along a virtual terrain 74 corresponding to the mine site 12. The modeled or virtual lanes 76, 132, 162, 192, and 194 have a plurality of measurable constraints, such as, for example, width w₁ or w₂, curvature radius r₁ or r₂, and/or inclination angle a₁ or a₂, based on constraints of the one or more proposed roads. Virtual machine footprints 86, 110, 164, and 198-210 corresponding to real world autonomous machines 16 and 18 are created in the virtual environment 70 and moved along the virtual lanes 76, 132, 162, 192, and 194 according to virtual machine movement profiles 88, 112, and 64 that correspond to actual machine movement profiles, such as 38, of the machines 16, 18. While the virtual machine footprints 86, 110, 164, and 198-210 are moved, the footprints 86, 110, 164, and 198-210 and virtual movements are compared to the measurable lane constraints and additional criteria to evaluate suitability of the virtual lanes 76, 132, 162, 192, and 194. Acceptable or preferred lanes may then be constructed at the mine site 12 and incorporated into route plans 62 for the autonomous machines 16 and 18.

Since work sites, such as mine sites, are dynamic and require the construction or modification of roads relatively frequently, the disclosed virtual environment and method may result in a significant reduction in time and costs for route planning purposes. In particular, the virtual environment and method disclosed herein may be used to validate proposed lanes and roads prior to their actual construction in the real world and, thus, reduce the possibility that a constructed road will need to be modified or moved based on unsuitability. In addition, the virtual environment and method are particularly useful for route planning for autonomous machines, since the control of the autonomous machines may be more precisely replicated in the virtual environment.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method for sorting among a plurality of potential route plans for operating an autonomous ground based machine at a work site, the method comprising:
creating a virtual model of a terrain of the work site;
creating a first virtual lane within the virtual model, wherein the first virtual lane corresponds to a first proposed route plan of the plurality of potential route plans and has at least one measurable lane constraint;
creating a first virtual machine footprint having a first virtual movement profile, wherein the first virtual machine footprint corresponds to an actual footprint of the autonomous ground based machine and the first virtual movement profile corresponds to an actual autonomous movement profile of the autonomous ground based machine;
moving the first virtual machine footprint from a starting position along the first virtual lane to an ending position along the first virtual lane according to the first virtual movement profile;
during the moving step, comparing the first virtual machine footprint to the at least one measurable lane constraint; and
designating the first proposed route plan as either viable or unacceptable based on the comparison of the first virtual machine footprint to the at least one measurable lane constraint.

2. The method of claim 1, wherein the moving step includes moving the first virtual machine footprint according to a predetermined acceleration rate, a predetermined deceleration rate, and a predetermined turning radius.

3. The method of claim 1, wherein the comparing step includes comparing the first virtual machine footprint to at least one of a width of the first virtual lane, a grade of the first virtual lane, and a curvature of the first virtual lane.

4. The method of claim 1, further including:
creating a second virtual machine footprint having a second virtual movement profile that is different than the first virtual movement profile;
moving the second virtual machine footprint along the first virtual lane according to the second virtual movement profile;
comparing the second virtual machine footprint to the at least one measurable lane constraint while the second virtual machine footprint moves along the first virtual lane; and
designating the first proposed route plan as either viable or unacceptable based on the comparison of both of the first virtual machine footprint and the second virtual machine footprint to the at least one measurable lane constraint.

5. The method of claim 4, further including:
modifying movement of one of the first virtual machine footprint and the second virtual machine footprint based on a current virtual position of another of the first virtual machine footprint and the second virtual machine footprint.

6. The method of claim 4, further including:
moving the first virtual machine footprint and the second virtual machine footprint according to a predetermined work cycle, wherein the predetermined work cycle corresponds to the first proposed route plan;
measuring at least one of a cycle time and a wait time corresponding to movement of the first virtual machine footprint and the second virtual machine footprint according to the predetermined work cycle a predetermined number of times;
comparing the at least one of the cycle time and the wait time to an acceptable time value; and
designating the first proposed route plan as either viable or unacceptable based on the comparison of the at least one of the cycle time and the wait time to the acceptable time value.

7. The method of claim 4, further including:
creating a second virtual lane within the virtual model, wherein the second virtual lane corresponds to the first proposed route plan and has at least one measurable lane constraint, wherein the first virtual lane and the second virtual lane intersect; and
moving a plurality of virtual machine footprints along both of the first virtual lane and the second virtual lane.

8. The method of claim 7, further including:
moving the plurality of virtual machine footprints according to a predetermined work cycle, wherein the predetermined work cycle corresponds to the first proposed route plan;
measuring at least one of a cycle time and a wait time corresponding to movement of the virtual machine footprints according to the predetermined work cycle a predetermined number of times;
comparing the at least one of the cycle time and the wait time to an acceptable time value; and
designating the first proposed route plan as either viable or unacceptable based on the comparison of the at least one of the cycle time and the wait time to the acceptable time value.

9. A virtual environment for sorting among a plurality of potential route plans for operating an autonomous ground based machine at a work site, comprising:
a virtual model of a terrain of the work site;
a first virtual lane within the virtual model, wherein the first virtual lane corresponds to a first proposed route plan of the plurality of potential route plans and has at least one measurable lane constraint;
a first virtual machine footprint having a first virtual movement profile, wherein the first virtual machine footprint corresponds to an actual footprint of the autonomous ground based machine and the first virtual movement profile corresponds to an actual autonomous movement profile of the autonomous ground based machine;
an electronic processor configured to move the first virtual machine footprint from a starting position along the first virtual lane to an ending position along the first virtual lane according to the first virtual movement profile, compare the first virtual machine footprint to the at least one measurable lane constraint while the first virtual machine footprint is moving, and designate the first proposed route plan as either viable or unacceptable based on the comparison of the first virtual machine footprint to the at least one measurable lane constraint.

10. The virtual environment of claim 9, wherein the first virtual movement profile includes a predetermined acceleration rate, a predetermined deceleration rate, and a predetermined turning radius.

11. The virtual environment of claim 9, wherein the at least one measurable lane constraint includes at least one of a width of the first virtual lane, a grade of the first virtual lane, and a curvature of the first virtual lane.

12. The virtual environment of claim 9, wherein the electronic processor is further configured to:
create a second virtual machine footprint having a second virtual movement profile that is different than the first virtual movement profile;
move the second virtual machine footprint along the first virtual lane according to the second virtual movement profile;
compare the second virtual machine footprint to the at least one measurable lane constraint while the second virtual machine footprint moves along the first virtual lane; and
designate the first proposed route plan as either viable or unacceptable based on the comparison of both of the first virtual machine footprint and the second virtual machine footprint to the at least one measurable lane constraint.

13. The virtual environment of claim 12, wherein the electronic processor is further configured to:
modify movement of one of the first virtual machine footprint and the second virtual machine footprint based on a current virtual position of another of the first virtual machine footprint and the second virtual machine footprint.

14. The virtual environment of claim 12, wherein the electronic processor is further configured to:
move the first virtual machine footprint and the second virtual machine footprint according to a predetermined work cycle, wherein the predetermined work cycle corresponds to the first proposed route plan;
measure at least one of a cycle time and a wait time corresponding to movement of the first virtual machine footprint and the second virtual machine footprint according to the predetermined work cycle a predetermined number of times;
compare the at least one of the cycle time and the wait time to an acceptable time value; and
designate the first proposed route plan as either viable or unacceptable based on the comparison of the at least one of the cycle time and the wait time to the acceptable time value.

15. The virtual environment of claim 12, wherein the electronic processor is further configured to:
create a second virtual lane within the virtual model, wherein the second virtual lane corresponds to the first proposed route plan and has at least one measurable lane constraint, wherein the first virtual lane and the second virtual lane intersect; and
move a plurality of virtual machine footprints along both of the first virtual lane and the second virtual lane.

16. The virtual environment of claim 15, wherein the electronic processor is further configured to:
move the plurality of virtual machine footprints according to a predetermined work cycle, wherein the predetermined work cycle corresponds to the first proposed route plan;
measure at least one of a cycle time and a wait time corresponding to movement of the virtual machine footprints according to the predetermined work cycle a predetermined number of times;
compare the at least one of the cycle time and the wait time to an acceptable time value; and
designate the first proposed route plan as either viable or unacceptable based on the comparison of the at least one of the cycle time and the wait time to the acceptable time value.
